(19) United States
(12) Patent Application Publication
(10) Pub. No.: US 2014/0095032 A1
(43) Pub. Date: Apr. 3, 2014

(54) REAL TIME SCALE COMMUNICATION BETWEEN MATERIAL HANDLING DEVICES

(71) Applicants: Ryan Mulder, Sheldon, IA (US); Robert Koerselman, Boyden, IA (US)

(72) Inventors: Ryan Mulder, Sheldon, IA (US); Robert Koerselman, Boyden, IA (US)

(21) Appl. No.: 13/632,715

(22) Filed: Oct. 1, 2012

(51) Int. Cl. G06Q 50/02

(52) U.S. Cl. CPC G06Q 50/02
USPC 701/50

(57) ABSTRACT

A system is provided for communication between material handling devices. The system includes a first material handling device with a first scale and a first controller adapted to receive information from the first scale, a second material handling device with a second scale, and a communication link between the first and second material handling devices. Preferably the second material handling device also includes a second controller adapted to receive information from the second scale and transmit same to the first controller. The first controller is also adapted to control a means for moving material, such as an auger, from the first material handling device to a transport apparatus. Moreover, the first controller is capable of displaying real time information or measurements regarding the weight of material located in the first material handling device, second and subsequent material handling devices, and a transport apparatus.

### FIELD OF THE INVENTION

The present invention relates generally to the agricultural field. More specifically, the present invention relates to a system that links pieces of agricultural equipment, some of which include a scale that transmits measurements to an electronic controller. Multiple electronic controllers may be employed to send information about each piece of equipment over a network to other pieces of equipment.

### BACKGROUND

Harvest is generally a very busy time of year for those in the agriculture industry. Time and efficiency are important factors for a successful harvest. The task requires use of many resources, including equipment and personnel. For example, a typical grain harvest operation includes at least one combine to remove a crop from a field, but more often includes approximately three combines per field. In operations where a grain is to be harvested, usually each combine dispenses harvested product into a grain cart, which a tractor pulls alongside the combine. The grain cart includes a means for moving the grain from the cart and unloading it into an apparatus that will transport the grain to a permanent or semi-permanent destination, such as a grain elevator, biofuel plant, or grain bin. Such apparatuses include, but are not limited to, grain wagons and semi-trucks. Alternatively, the grain cart may unload material into a permanent or semi-permanent location itself.

Most farms are measured in sections of land, with a section being approximately one square mile, and one quarter section being a common farm size. One quarter section is approximately 160 acres. Most agricultural operations require three combines to harvest a quarter section of grain. Accordingly, there are usually multiple grain carts used in the same field during harvest.

One semi-permanent destination for a harvested product, such as a harvested grain, is a surge bin. A surge bin is a large, yet portable, storage apparatus for use during harvest. Similar to other pieces of agricultural equipment, the surge bin is pulled by a tractor from location to location. One use for a surge bin is to place same in a field to be harvested. Once the combines fill their respective grain carts, the grain carts unload harvested material into the surge bin via means including but not limited to an auger. The surge bin holds the grain until a transport apparatus, such as a truck or grain wagon, is available to move the product to a destination located outside of the field. At such time as a transport apparatus becomes available, the harvested product is moved to same, such as via an auger attached to the surge bin. In addition to the above-described harvest scenario, surge bins are also useful for longer term storage, such as by an elevator or co-op.

Grain carts may be equipped with scales for measuring the amount of material located in the storage bin of the cart. A scale is useful for tracking the yield in a field or part of a field, analyzing yield from a specific type of seed, tracking harvested product in a sharecropping field, verifying and calibrating a combine yield monitor, and proving yields for federal crop insurance. One such scale is the Avery Weigh-Tronix grain cart weighing systems. However, these scales do not communicate with other pieces of agricultural equipment and, in particular, the displays or controllers of these scales are unable to calculate a real-time weight of material in a piece of agricultural equipment. Accordingly, there is a need in the art for a system wherein pieces of agricultural equipment communicate and transmit information related to the weight of material located in one material handling device to another material handling device. There is further a need in the art for an electronic controller to receive information regarding the amount of material in a plurality of material handling devices and which can regulate the unloading of material from one material handling device to another piece of machinery. There is further a need in the art for a system that can calculate the real-time weight of material in equipment such as grain carts, surge bins, and or semi-trucks and grain wagons by analyzing measurements such as one or more of flow rate, scale measurements, and the amount of material that has left a first piece of equipment, such as by an auger, but not yet entered a second piece of equipment. Such a system would be particularly beneficial in harvest operations employing a surge bin, which is a central hub for harvested material.

### SUMMARY

The present invention provides a system for communication between multiple material handling devices. The first material handling device includes a first scale and a first controller adapted to receive information from the first scale. The first scale measures the weight of harvested product located in the first material handling device and transmits measurement information to the first controller. A second material handling device also includes a second scale and, in the preferred embodiment, a second controller. The second scale transmits measurement information to the second controller. The first and second controllers are connected via a communication link, such as via wife, wherein the controllers may be tracked and identified using internet protocol addresses. In the preferred embodiment the first and second material handling devices include a surge bin and grain cart, respectively.

Also included in the system of the present invention is a material transport apparatus. The material transport apparatus receives harvested material from a material handling device, such as a surge bin, and transports same to a more permanent destination, such as an elevator, co-op or grain bin. Oftentimes, the material transport apparatus may only carry a limited weight of harvested material, which is particularly the case for semi-trucks traveling on public roadways. An electronic controller of the present invention, which in the preferred embodiment is the first electronic controller, is adapted to receive information about the capacity of material transport apparatuses.

Further, the electronic controller is adapted to control or regulate the unloading of material from a material handling device. To that end, in the preferred embodiment, the electronic controller is adapted to control at least one of an auger and an auger door located on the material handling device via a hydraulic system, motors, or a combination thereof. The controller may open and close the auger door(s) to allow material to enter the auger. Moreover, the electronic controller can automatically start and stop the auger to further control the unloading process. The first scale is also capable of sending information to the controller regarding the amount of material that has been unloaded. The first material handling device of the present invention may receive material from a second material handling device and unload material into a material transport apparatus simultaneously, with the first controller instantaneously displaying real-time information regarding the amount of material in each device and apparatus. Accordingly, in embodiments including a grain cart and a surge bin, the grain cart operator need not wait for the surge bin to finish filling a semi-truck or other transport apparatus before filling the surge bin with material, thus saving time during harvest. Because the controller is able to both receive signals from the scale and the second controller as well as calculate the amount of material moving through the auger, the controller will accurately display the amount of grain in the first material handling device during simultaneous loading and unloading of material.

The system of the present invention may further include means for manually operating an auger of a material handling device. In the preferred embodiment, a joystick is used to manually operate an auger via the aforementioned hydraulic system, motors or a combination thereof. Moreover, the data from at least one of the controllers is transferable to other computer or memory means, such as via the World Wide Web, user command, and/or real-time transfer.

### BRIEF DESCRIPTION OF THE DRAWINGS

FIG. 1 is a schematic diagram of a first material handling device, including a first scale, first controller, auger, and joystick; a second material handling device including a second scale and second controller; and a communication link between the first controller and second controller in accordance with one or more examples of a system of the present invention.

FIG. 2 is a schematic diagram of four material handling devices and two material transport devices in accordance with one or more examples of a system of the present invention.

FIG. 3 is a front elevational view of a first material handing device in accordance with one or more examples of a system of the present invention.

FIG. 4 is a front elevational view of a second material handling device moving material to a first material handling device, which in turn is moving material to a transport apparatus in accordance with one or more examples of a system of the present invention.

FIG. 5 is a cross-sectional view of the material handling device of FIG. 3 taken along the lines 5-5 in FIG. 3.

FIG. 6 is a perspective view of a first controller in accordance with one or more examples of a system of the present invention.

FIG. 7 is a perspective view of a second controller in accordance with one or more examples of a system of the present invention.

FIG. 8 is a flow chart according to a method for using one or more examples of a system of the present invention.

FIGS. 9-17 are user interfaces of the first controller in accordance with one or more examples of a system of the present invention.

### DETAILED DESCRIPTION

The following is a detailed description of an embodiment of a real time scale communication system 100 (sometimes “system”) between material handling devices. One particular use of such a system 100 is for measuring the amount of harvested product that has been loaded into a grain cart and/or a surge bin and communicating data regarding same to each other and, if desired, to other pieces of agricultural equipment. Other uses include measuring the movement of material, including but not limited to a harvested product, between material handling devices as well as measuring and controlling the movement of a harvested product from any material handling device to a transport apparatus. For ease of discussion and understanding, the following detailed description and illustrations often refer to a first material handling device 102 that is a surge bin and a second material handling device 104 that is a grain cart. Subsequent material handling devices are often referred to as grain carts, also. Accordingly, the described embodiment includes one surge bin 102 that is in communication with a plurality of grain carts. However, it should be appreciated that the system of the present invention may be used with any agricultural equipment wherein it is useful to measure an amount of material, including but not limited to devices used to plant seed, devices used to spray material onto a field, and devices used to harvest material. Moreover, the system 100 of the present invention will be useful for elevators or co-ops as well as payload front end loaders that also have scales. Oftentimes, the detailed description will refer to a material that is a harvested product, particularly a grain. However, as discussed above, it should be appreciated that the present invention is for use with any material.

In its simplest embodiment, the system 100 of the present invention includes a first material handling device 102 which includes a first scale 120 and a first electronic controller 122, a second material handling device 104 that includes a second scale 124, and a communication link 103 between the first material handling device 102 and the second material handling device 104, which allows the first material handling device 102 and the second material handling device 104 to communicate with each other. The first controller 122 is adapted to determine, and display, the quantity of material in the first material handling device 102, second material handling device 104, and/or a material transport apparatus 116. In the preferred embodiment, the first electronic controller 122 is adapted to receive information regarding the first scale 120 directly from the scale 120. Further, the first electronic controller 122 is adapted to receive information regarding the second scale 124 via the communication link 103. As will be discussed in further detail below, the first electronic controller 122 is further adapted to receive information about at least a first material transport apparatus 116 and control the unloading of material into the first material transport apparatus 116 as well as any other material transport apparatuses. Moreover, the first electronic controller 122 is adapted to determine the real-time quantity, preferably in weight, of material in each piece of agricultural equipment linked by the system, including but not limited to the first material handling device 102, second material handling device 104, and material transport apparatus 116. To do so, the first electronic controller 122 evaluates factors including but not limited to, the scale readings in the first material handling device 102, second material handling device 104, and the material in transit between the two devices 102, 104, such as material located in the second material handling device material moving means, which in the preferred embodiment is an auger 125.

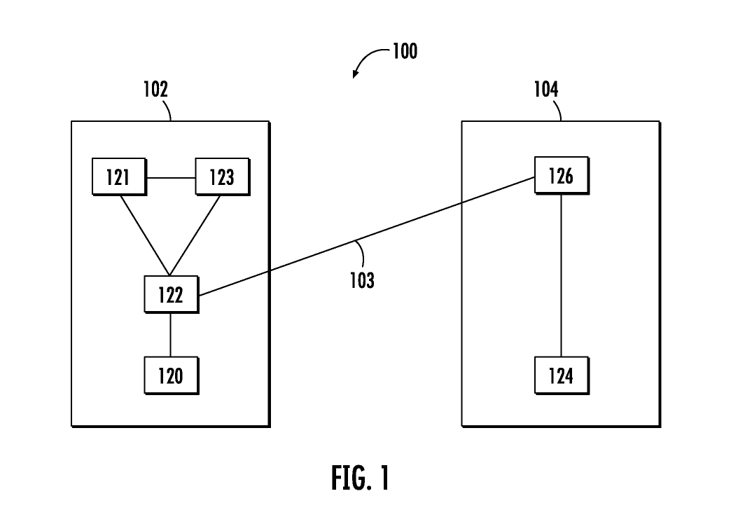

Referring to FIG. 1, in the preferred embodiment, the system 100 of the present invention further includes a second controller 126 that is adapted to receive information from the second scale 124. Moreover, the communication link 103 is a wifi connection between the first controller 122 and the second controller 126 or, as in the preferred embodiment, between a wifi transmitter attached to the second controller 126 and a wifi receiver attached to the first controller 122. As one of skill in the art will appreciate, the controllers 122 and 126 may include wifi client cards for communication. Moreover, the communication link 103 may include an intermediary, such as a router, to facilitate communications. Examples of suitable controllers include those in the Avery Weigh-Tronix Model 3060 system. The first material handling device 102 may also include means for manually operating an auger or auger assembly 121 or similar material movement means, such as a joystick 123.

The second controller 126 receives and displays real-time information received from the second scale 124. Moreover, the second controller 126 sends real-time information received from the second scale 124 to the first controller 122, which, accordingly, displays same. As discussed above, this communication may be via a wifi connection or network that is transmitted from a wifi transmitter located on the first material handling device 102 to a wifi receiver located on the second material handling device 104. In the preferred embodiment, the first 122 and second 126 controller communicate with each other via an intermediary router. However, one of skill in the art will appreciate that any wifi setup may be used, such as through independent or integrated wifi client cards in various network layouts, including but not limited to ad-hoc, mesh, direct, ring, tree, hub-and-spoke/star, and/or a combination thereof. The first controller 122 also receives and displays real-time information from the first scale 120. Moreover, the first controller 122 calculates the amount of material unloaded and moved to a material transport apparatus 116. Accordingly, the first controller 122 has the ability to receive and/or calculate and display information about the amount of material in the first material handling device 102, second material handling device 104, and a material transport apparatus 116 simultaneously. The information about the amount of material in the first material handling device 102, second material handling device 104, and a material transport apparatus 116 is displayed in real-time or, in other words, instantaneously.

Moreover, the first controller 122 may track and display information regarding a plurality of material handling devices. A significant advantage of these features is the ability of the first material handling device 102 to receive material from a plurality of material handling devices and unload material into a transport apparatus 116 all simultaneously. Prior art systems require that a surge bin be loaded and unloaded at separate times in order to track the amount of material being transferred. Accordingly, the system 100 of the present invention allows for increased efficiency and speed in the harvest operation. Because the first controller 122 syncs with second 104 and subsequent material handling devices, the process of which will be described in further detail below, the first controller 122 is aware that material is entering the first material handling device 102, even if material is leaving the device 102 at the same rate. Moreover, because the first controller 122 is generally controlling, or able to receive information regarding, unloading of the material from the first material handling device 102, it is able to calculate the flow of material out of the first material handling device 102. Accordingly, the first controller 122 may display data that is received from scale measurements or that is calculated by the first controller 122 based on information known to the controller 122.

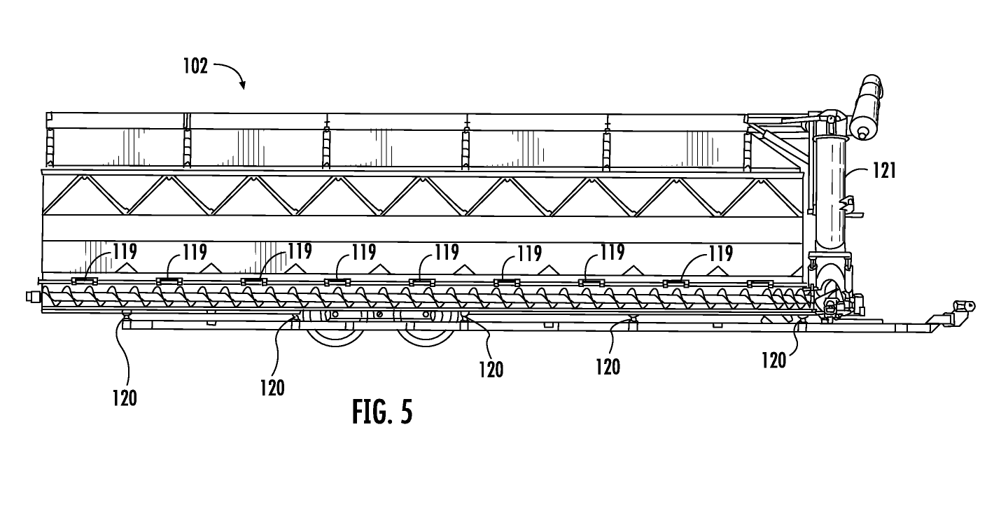

The scales of the preferred embodiment are pancake scales with a capacity of 50,000 pounds. Generally, each material handling device has a plurality of pancake scales, which are known in the art. For example, in embodiments where the first material handling device is a surge bin, the surge bin preferably includes ten pancake scales, five on each of the right and left sides of the first material handling device 102 frame, as illustrated in the cross-sectional view of FIG. 5. Moreover, in the preferred embodiment, there are strong linkages along the bottom frame of the material handling device to isolate vertical and horizontal movement of the frame. As is known in the art, pancake scales should be shielded from side-to-side stress. It should be appreciated that any number and type of scales may be used to measure material in the material handling devices without departing from the scope of the present invention. Further, the type and number of scales used will depend on many factors including but not limited to the type of material handling device at issue and the amount of material that it may hold. Preferably, the scales feed data to side-mounted input modules on the frame of the material handling device. For example, in a surge bin, the scales feed data to two side-mounted input modules on the surge bin.

As will be discussed in further detail below, the connections shown in FIG. 1 may include intermediary members without departing from the scope of the invention. By way of examples only, as discussed above, the wifi communication link may include an intermediary router and/or wifi cards located within the first 122 and second 126 controllers. Moreover, the first controller 122, auger assembly 121, and joystick 123 may be connected to a hydraulic control block and/or motors for carrying out the operations of the auger assembly 121 controlled by the first controller 122 and joystick 123 or separately via a bank of hydraulic control levers.

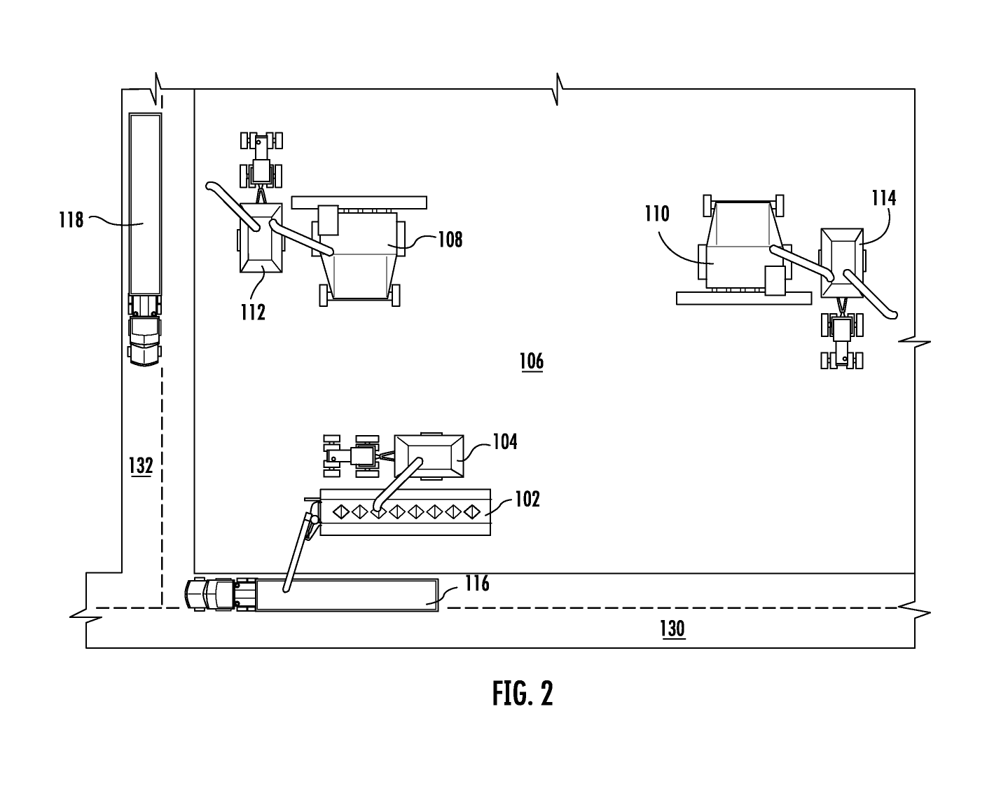

Referring to FIG. 2, a schematic of an embodiment of the present invention for use in a harvest operation is illustrated. FIG. 2 illustrates a number of pieces of agricultural equipment that are harvesting a field 106. The field is bordered by two roads 130, 132. Assisting in the harvest operation are a first material handling device 102 and a second material handling device 104. Also present are a first combine 108, second combine 110, third material handling device 112, fourth material handling device 114, first material transport apparatus 116, and second material transport apparatus 118. In the illustrated embodiment, the first material handling device 102 is a surge bin and the second 104, third 112, and fourth 114 material handling devices are grain carts that travel alongside combines to receive harvested product. It should be appreciated that any number and type of material handling devices may be utilized in a system 100 of the present invention. Each of the first material handling device 102, second material handling device 104, third material handling device 112, and fourth material handling device 114 includes at least one scale for measuring the amount of harvested product in the storage container of the respective device and an electronic controller for receiving information from one or more scales. Further, in the illustrated embodiment, the first material transport apparatus 116 and second material transport apparatus 118 are semi-trucks, the trailers of which will receive harvested material from the first material handling device 102.

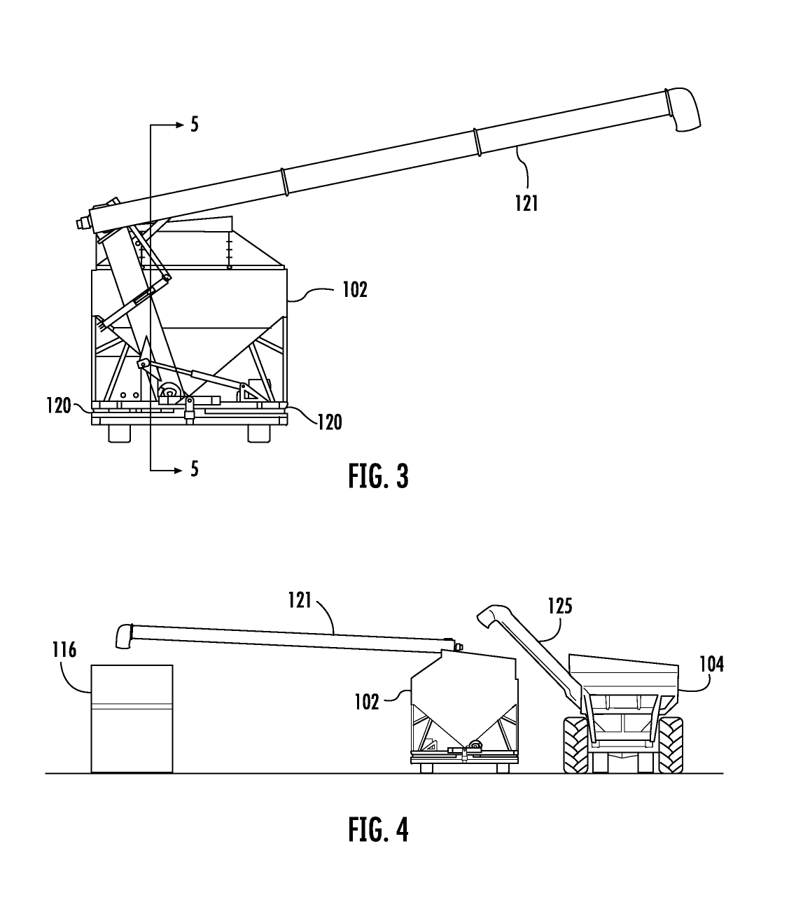

Referring to FIGS. 3-5, embodiments of material handling devices of the present invention are illustrated. A first material handling device 102 is shown in FIG. 3. Specifically a surge bin in shown. The first material handling device 102 includes an auger 121 for moving material, such as a harvested grain, from the first material handling device 102 to a transport apparatus 116. FIG. 4 shows a first material handling device 102, second material handling device 104, and material transport apparatus 116 of the present invention. The second material handling device 104, which is a grain cart in this illustration, is positioned to unload material via a second material handling device auger 125 into the first material handling device 102. The first material handling device 102 in this illustration is also a surge bin. The first material handling device 102 also includes an auger 121 to move material. A material transport apparatus 116, which in the illustration is the trailer of a semi-truck, is positioned to receive material from the first material handling device 102. FIG. 5 is a cross section of a first material handling device 102 of the present invention taken along the lines 5-5 in FIG. 3. Five scales 120 of the system 100, which will be discussed in further detail below, are shown. Also shown are nine auger doors 119. As will be discussed herein, the first controller 122 is adapted to control and manipulate the auger doors 119. When the auger doors 119 are open material may fall from the first material handling device 102 container to an auger that spans the length of the material handling device 102 to push material forward to the auger 121.

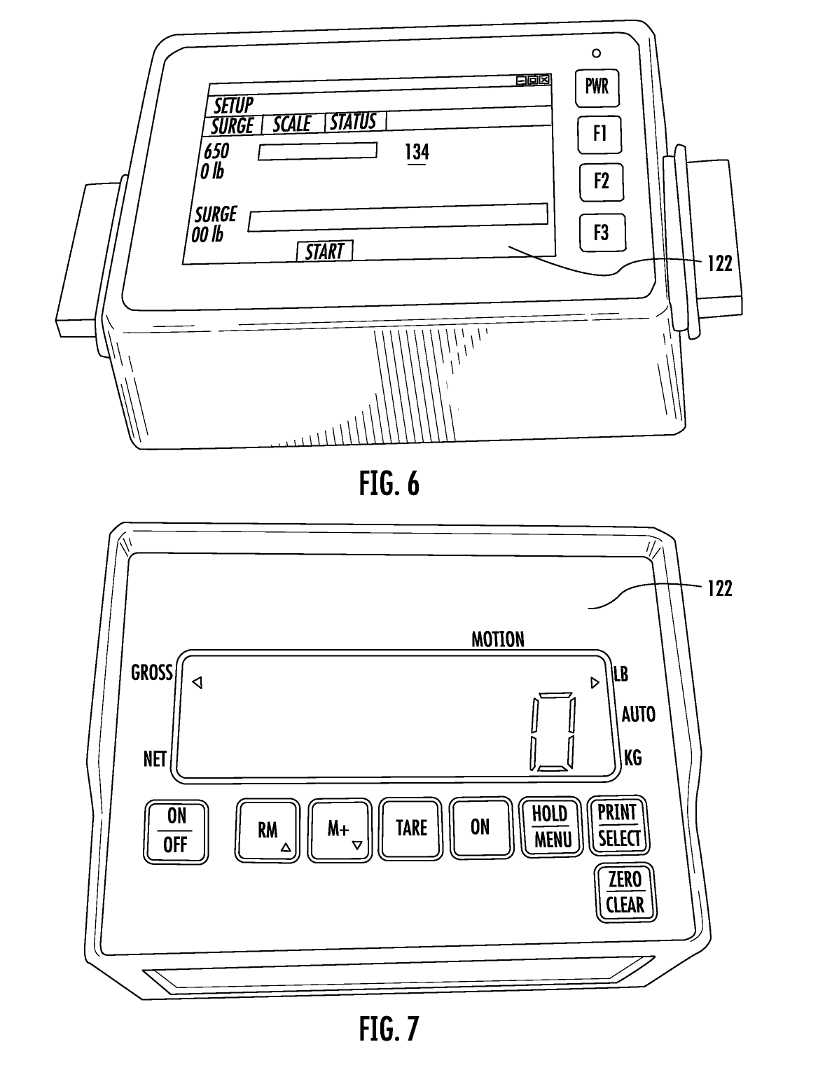

In the preferred embodiment, the first controller 122, which is connected to the first material handling device 102, acts as a central or system controller for the entire system 100. Accordingly, the system controller is connected to a surge bin, which is a central loading and unloading point for harvested material. FIG. 6 illustrates an embodiment of a first controller 122 of the present system. The first controller 122 is adapted to receive information from the first scale 124 and any other scales in the system. In the preferred embodiment, the first controller 122 receives information from the first scale via a hardwired connection. Accordingly, the first controller 122 is usually located in close proximity to the first material handling device 102. To that end, the first controller 122 is preferably located in the cab of the tractor pulling the surge bin from location to location. However, the first controller could be located anywhere, such as on the surge bin itself. In the preferred embodiment, the tractor is used to power the hydraulic, power take off, and electronic components of the system 100. However, it should appreciated that the power for the above-referenced systems could come from another source, such as a source self-contained on the first material handling device 102. As can be seen in FIG. 6, the first controller 122 includes a large touch screen 134 for programming the first controller 122 and initiating an unloading process, which will be discussed in further detail below.

One of skill in the art will recognize that the first controller 122 may receive information from the first scale 120 by any means known in the art, now or in the future including but not limited to a wifi connection or hardwire. In the preferred embodiment, the first controller 122 receives information from the other scales via other controllers that are attached to each scale, such as the second controller 126 which is attached to the second scale 124 and will be discussed in further detail below. One of skill in the art will appreciate that the first controller 122 may receive information from other scales by any means known in the art now or in the future, such as by a direct communication link between the first controller 122 and the other scales, including but not limited to a wifi connection. In the wifi network of the preferred embodiment, both the first controller 122 and second controller 126 are identified and tracked using an internet protocol address assigned to each controller. The first controller 122 is further adapted to receive information regarding transport apparatuses. Additional functions and advantages of the first controller 122 will be discussed herein below.

In the preferred embodiment, the second controller 126 and any subsequent controllers are generally identical and need not have all of the functionality of the first controller 122. However, the second 126 and subsequent controllers may include additional functionality without departing from the scope of the present invention. Preferably, the second controller 126 need only receive information from the second scale 124 and transmit same to the first controller 122. The second controller 126 may transmit the information directly or by way of a wifi transmitter connected to the controller 126. Referring to FIG. 7, an embodiment of a second controller 126 is illustrated. As can be seen, the screen of the second controller 126 is smaller than that of the first controller 122. Further, the screen of the first controller 122 is a touch screen 134, whereas the screen of the second controller 126 is not. One of skill in the art will recognize that the second controller 126 may include a touch screen similar to the first controller 122.

In the preferred embodiment, the second controller 126 is hardwired to the second scale 124. However, the second controller 126 may receive information from the second scale 124 by any method known in the art now or in the future. Preferably, the second controller 126 transmits information to the first controller 122 by way of a wifi transmitter in a wifi network, but any method known in the art now or in the future may be used. In the wifi network of the preferred embodiment, the second controller 126 is identified and tracked using an internet protocol address. Generally the second controller 126 is located in the cab of the tractor pulling the second material handling device 104, however, one of skill in the art will recognize that the second controller 126 may be located anywhere as the application requires and allows.

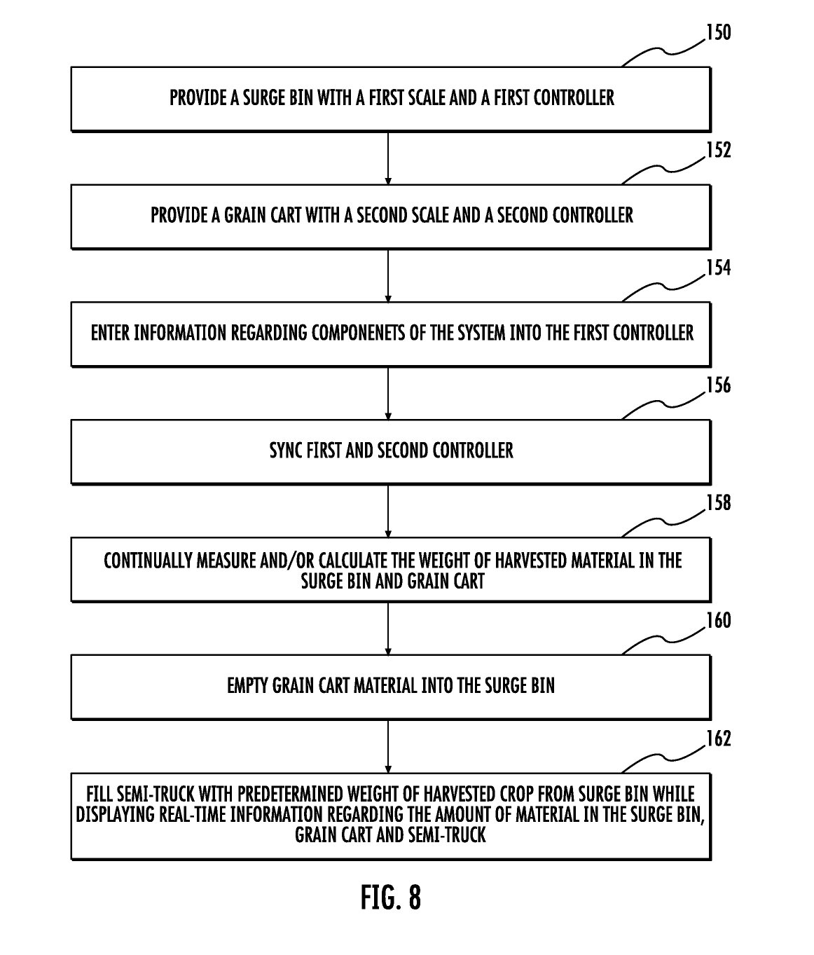

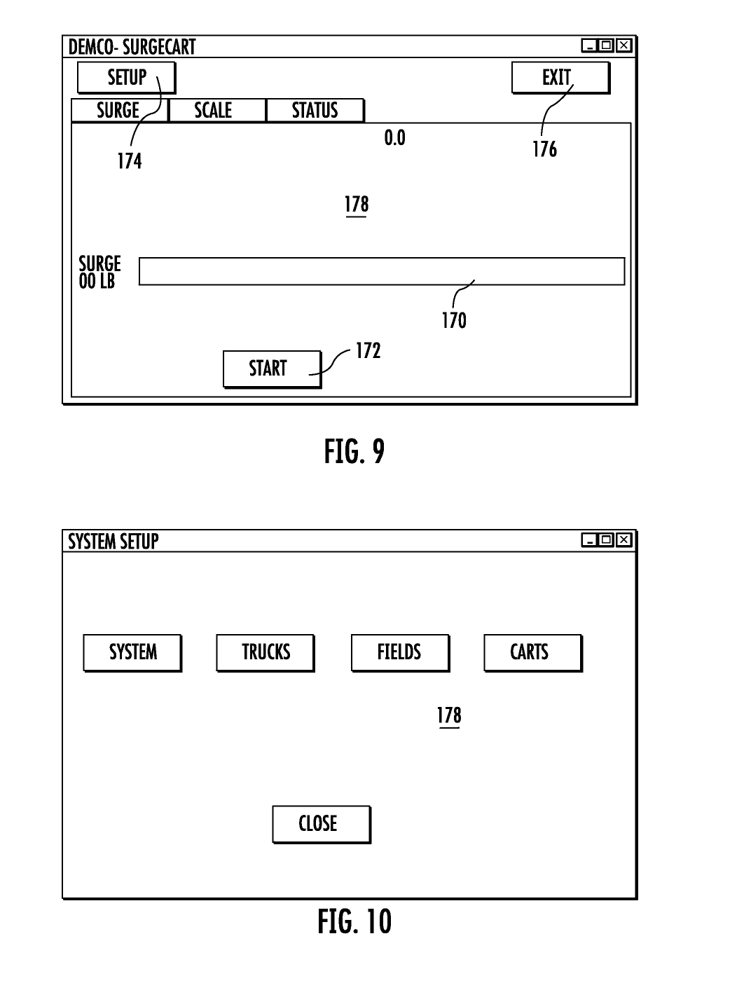

Referring to FIG. 8, a flow chart for using the preferred embodiment of the present invention is provided. In the preferred embodiment, unless otherwise indicated, the features of the system 100 are automatic, except the power control of the various components. In the first block 150, a first material handling device 102 that is a surge bin including a first scale 120 and controller 122 are provided. Also provided, in block 152, is a second material handling device 104 that is a grain cart and includes a second scale 124 and controller 126. Next, as provided in block 154, a user will enter information into the first controller 122 regarding system setup, including second 104 and subsequent material handling devices and first 116 and subsequent material transport apparatuses to be filled by the first material handling device 102. Referring to FIG. 9, the first main screen 168 of the first controller 122 is shown. In the preferred embodiment, the first controller 122 runs a Windows CE operating system, although any operating system may be used without departing from the scope of the present invention. The first main screen 168 shows the weight of material located in the first material handling device 102, or surge bin, by way of a bar graph 170, provides a “START” button 172 for unloading material from the surge bin into a transport apparatus, a “Setup” button 174, and an “Exit” button 176. By touching the “Setup” button 174, the System Setup option screen 178 is accessed. As illustrated in FIG. 10, by accessing this screen 178, the user can choose to view and/or enter information regarding the system as a whole, the trucks associated with the system, the fields associated with the system, and the grain carts associated with the system. By choosing the field option from the System Setup option screen 178, the user may enter information regarding the field or farm description and/or location.

By choosing the system option from the System Setup option screen 178, the user is taken to the System Setup data screen 180, which is illustrated in FIG. 11. At this screen, the user may view and enter/change data regarding the surge bin also known as the surge cart capacity, grain cart capacity, maximum truck fill weight, grain cart fill offset, shutdown time, and options associated with the auto adjustment feature, which will be discussed in further detail below. The surge bin capacity is the amount of material that the surge bin can hold. The value defines the size of the surge bin for the bar graph 170 of the main screen. The maximum grain cart capacity is associated with a bar graph that will be discussed in further detail below and represents the capacity of the largest grain cart of the system. Similarly, the maximum truck fill weight is associated with a bar graph that will be discussed in further detail below and represents the capacity of the largest semi-truck of the system.

The grain cart fill offset is a value for calibrating the calculations that the first controller 122 makes as it is filling a truck. This value is used to adjust the calculations regarding the material that has left the grain cart but has not yet landed in the surge bin, which increases the accuracy of the calculations. For example, faster flowing grain carts may need a different grain cart fill offset value than a slower grain cart. The user enters the applicable value. The shutdown is the time from when the first controller 122 triggers shutdown of the auger 121 on the surge bin to the time when the auger 121 stops moving material to the transport apparatus 116. At the end of the shut down time, the first controller 122 displays the final truck weight. The shutdown time is a user entered value based on how long it takes for the surge bin to empty material from the auger 121. Preact is the weight before the truck is full when the first controller 122 triggers the auger of the surge bin to shut down. The preact value is constantly autocorrected by the first controller 122 based on previous load error. Other listed values also relate to the automatic correcting feature of the system 100, which will be discussed in further detail below.

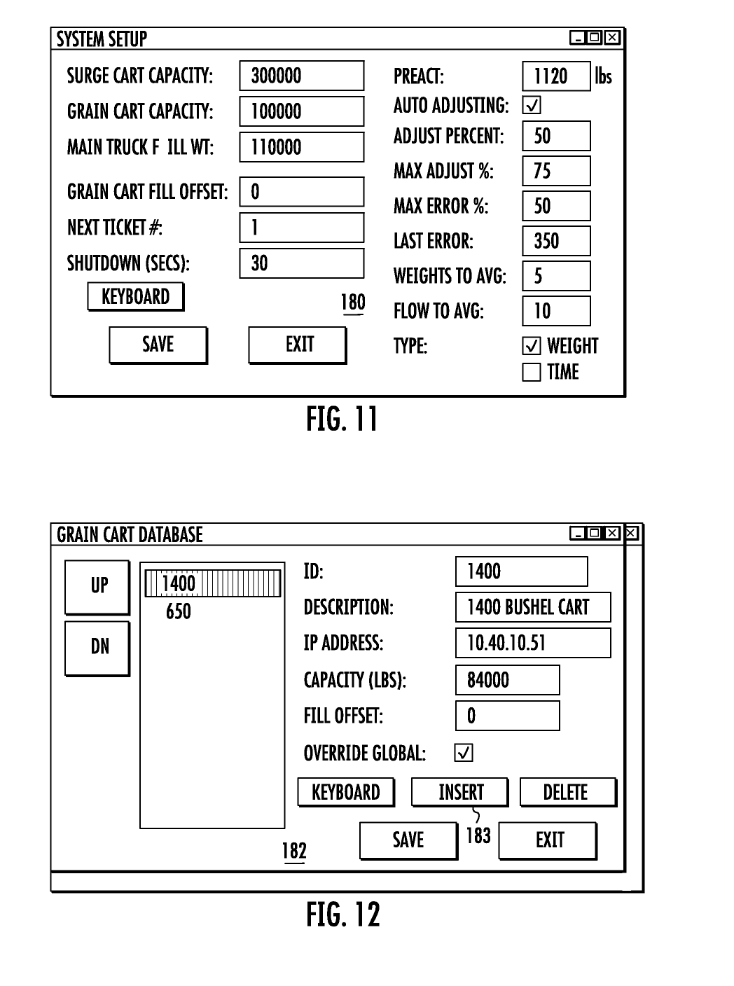

Referring again to the System Setup option screen 178 of FIG. 10, choosing the carts option will take the user to the Grain Cart Database screen 182, which is illustrated in FIG. 12. At this screen, the user can view, enter, and/or change information regarding the grain cart fleet that will be part of the system 100. The user may add a new grain cart by pressing the “Insert” button 183 and entering information regarding the new grain cart. In the illustrated example, two grain carts have been entered into the system 100, a 1400 bushel capacity cart and a 650 bushel capacity cart. The user enters an ID for the grain cart, which in the illustrated embodiment is the number “1400”. The user further enters a description for the cart, the IP address of the cart, the capacity in pounds of the cart, and the fill offset. The fill offset value is used to adjust the calculations regarding the material that has left the surge bin but has not yet landed in the transport apparatus 116, which increases the accuracy of the calculations. For example, faster flowing surge bins may need a different fill offset value than a slower surge bin. The user enters the applicable value. Each of the grain carts includes a wifi transmitter and/or receiver that is tracked and identified with an internet protocol (IP) address. Accordingly, in order for the first controller 122 to recognize a particular cart, its IP address must be provided.

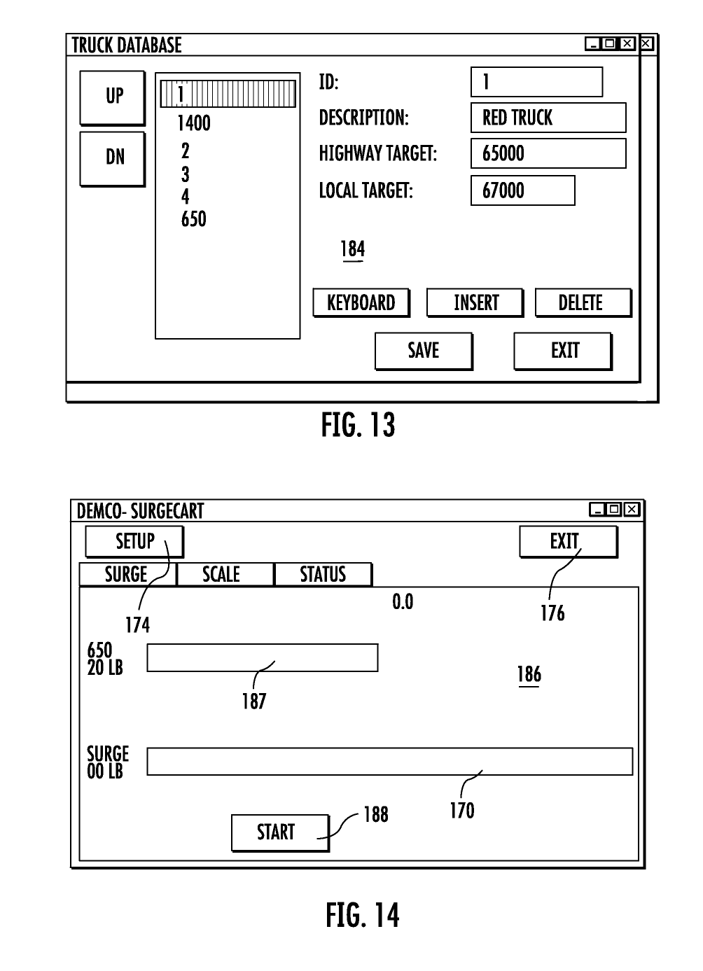

Choosing the trucks option in the System Setup option screen 178 of FIG. 10 will take the user to the Truck Database screen 184, provided in FIG. 13. The user may enter information regarding the truck fleet that will be used with the system at this screen 184. The information to be entered includes an ID, description, highway target weight, and local target weight. The ID and description are used to identify the particular truck at issue. In the illustrated example, the truck has an ID of “1” and can be further described as the “Red Truck” for easy identification. The highway target is the maximum weight of material that the truck may legally carry on the highway. The local target is the maximum weight of material that the truck may legally carry on local roads or, alternatively, may be a target capacity that has been entered for other reasons.

Next, referring to FIG. 8 block 156, the first controller 122 and second controller 126 are synched with each other. In the preferred embodiment, the two controllers may either be manually synched or automatically synched when the two controllers are in range of each other in the wifi network. Further, the second controller 126 and any other subsequent controllers include a small light that when lit signals that the controller is synched to the first controller 122. Referring to FIG. 8, block 158, the system then continually measures and/or calculates the weight of harvested material in the surge bin and any grain carts that are synched and in range. To that end, turning to FIG. 14, a second main screen 186 is provided wherein the first controller 122 has synched with a second controller 126. As can be seen, the second main screen 186 displays the weight of material in both the first 102 and second 104 material handling devices. In the illustrated example, the surge bin, or first material handling device 102, has not yet been filled with material and therefore displays a weight of zero pounds of material in the bin. The grain cart, or second material handling device 104, that has been synched with the first controller 122 is the 650 bushel grain cart discussed above. It has been filled with twenty pounds of material, which is displayed on the screen 186. If other material handling devices are synched with the first controller 122, those too will be displayed on the second main screen 186.

Referring to FIG. 8, block 160, the grain cart, or second material handling device 104 empties its harvested material into the first material handling device 102, such as by an auger 125 located on the second material handling device, as shown in FIG. 4. As the synched material handling devices empty into the surge bin, the first controller will display the real-time or instantaneous weight of material in the surge bin as well as the real-time or instantaneous decreasing weight of material in the grain cart. Referring to FIG. 8 block 162, once material has been loaded into the surge bin, the surge bin may unload the material into a transport apparatus 116, such as a semi-truck. When the user wishes to do so, pressing the “Start” button 188 on the second main screen 186 of FIG. 14 will initiate the unloading process. A significant advantage of the system 100 of the present invention is the ability of the first material handling device 102 to receive material from a second material handling device 104 and unload material into a material transport apparatus 116 simultaneously while still accurately displaying the weight of material in all three pieces of equipment.

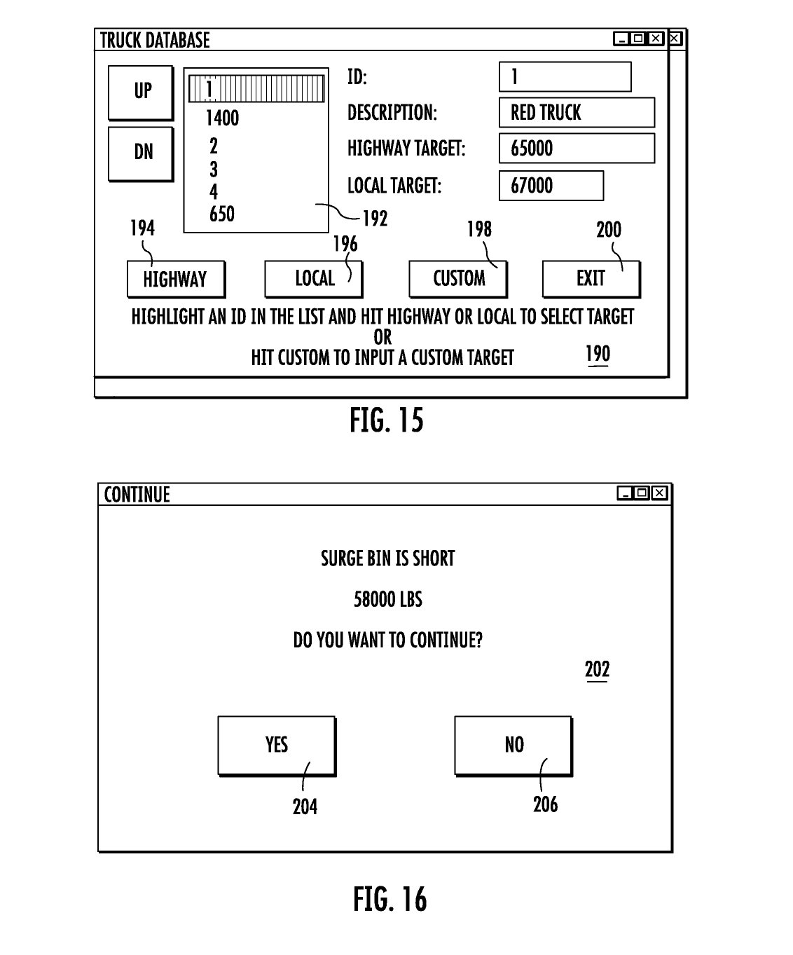

Once the user has pressed the “Start” button 188 on the second main screen 186, the first controller 122 will bring up a second truck database screen 190, shown in FIG. 15. This screen 190 allows the user to choose the transport apparatus 116 to be filled. Once at the second truck database screen 190, the user selects the transport apparatus or material handling device to be filled by highlighting the ID of the appropriate vehicle in the selection box 192 on the touch screen. The screen will display information regarding the selected vehicle that was inputted earlier in the process, including the ID, Description, Highway Target weight, and Local Target weight. Once the user has selected the appropriate vehicle to be filled, the user then must decide whether to fill the vehicle to the highway target weight, local target weight, or a custom weight. The user presses the “Highway” button 194 to fill the selected vehicle to the highway capacity, the “Local” button 196 to fill the selected vehicle to the local capacity, and the “Custom” button 198 to enter a different weight of material to be unloaded into the selected vehicle. The user may also exit the process by pressing the “Exit” button 200 of the touch screen 134. If the surge bin does not have enough material to fill the selected vehicle to the selected weight, the first controller 122 will display a warning screen 202, shown in FIG. 16, alerting the user to the shortage. The screen 202 requires the user to answer whether to continue the process by pressing the “Yes” button 204 or “No” button 206.

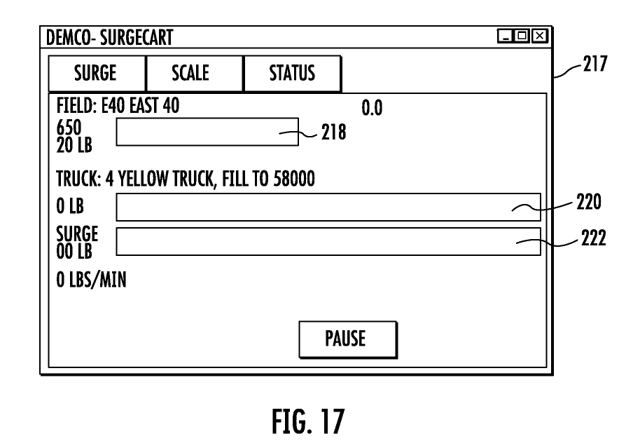

The first controller 122 displays a fill screen 208 during the unloading process, shown in FIG. 17. The fill screen 208 is similar to the main screens 168 and 186 in that it includes information regarding the weight of material in the surge bin or first material handling device 102 and information about any other synched material handling devices, such as the 650 bushel grain cart in the illustrated example. However, the fill screen 208 also includes information regarding the unloading process that is currently proceeding. Namely, the screen 208 displays information regarding which truck is being filled, the weight of material to be loaded into the truck, a bar graph 212 displaying the unloading progress, and the rate of unloading in pounds per minute. The first controller 122 receives signals from one or more scales located on the surge bin of the present invention to measure the weight of material in same. In the preferred embodiment, the first controller 122 uses weight readings to calculate and display flow rates. The first controller 122 regulates the auger doors 119, while the auger speed is constant. The first controller 122 displays the flow rate, which is influenced by the pressure necessary to auger the material. For example, a better flowing material will have a faster flow rate, which the first controller 122 will calculate based on weight readings from the first scale 124 and display a faster flow rate. The user may pause the unloading process by pressing the “Pause” button 210.

As mentioned briefly above, the first controller 122 controls or regulates the unloading of material. For purposes of illustration, the following example discusses the unloading of material into a first transport apparatus 116 that is a semi-truck or more specifically the trailer of same. It should be appreciated that the first controller 122 may control the unloading of material into any container, whether portable or not, or even onto the ground if necessary, without departing from the scope of the invention. As illustrated in FIGS. 3 and 4, in the preferred embodiment, the first controller 122 controls an auger assembly 121 that is attached to the first material handling device 102 and configured to move material from the device 102 to another vehicle. It should be appreciated that the first controller 122 may be adapted to control the unloading of material from the device 102 by any method known in the art now or in the future, including but not limited to a conveyer belt. The electronic controller 122 may be connected to the auger assembly 121 by any method known in the art now or in the future, including but not limited to, a wired connection or a wireless connection. In the preferred embodiment, the auger 121 movement is powered and manipulated by a hydraulic system. Specifically, the first material handling device 102 includes a hydraulic control block that is connected to both the first controller 122 and auger assembly 121 to carry out directional movement of the auger assembly 121 during filling. In addition, the first material handling device 102 includes one or more motors for powering the flighting within the auger assembly 121. Alternatively, the fighting within the auger assembly 121 may be mechanically powered from the power take off of the tractor. The one or more motors are also connected to the first controller 122 and auger assembly 121. As will be appreciated by one skilled in the art, the connection means between the first controller 122 and the hydraulic control block and motors as well as the connection means between the auger assembly 121 and hydraulic control block and motors may be any connection means known in the art now or in the future, including but not limited to a hardwired connection.

In addition, the auger assembly 121, or other material movement means, hydraulic control block, and/or motors may be manually controlled by any method known in the art now or in the future. In the preferred embodiment, the auger assembly 121 may be manually operated by a joystick 123. It is preferred that the first controller 122 regulates the rate of movement of the material through the auger assembly 121 by controlling the opening and closing of the auger doors 119, while the joystick 123 controls the position of the auger, if the auger is capable of movement. It should be appreciated that the material movement means of the present invention may be either stationary or capable of movement. The joystick 123 and first controller 122 are also connected, such as via a hardwire, so that the first controller 122 may send information to the joystick 123 regarding the automatic start and/or shut-down sequences, which will be discussed in further detail below.

Once the user instructs the first controller 122 to begin the unloading process, the controller 122 automatically controls the rate and timing of same, while the operator uses the joystick 123 to control the movement of the auger assembly 121. In the preferred embodiment, the first material handling device 102 includes at least one auger door and an internal auger for moving material to the auger assembly 121 that ultimately moves material from the device 102 to the transport apparatus 116. The first controller 122 controls the auger doors to allow grain to drop down to the internal auger and turns the auger assembly 121 on and off. In the preferred embodiment, the augers move at a constant speed of 500 revolutions per minute. It should be appreciated that the augers may move at any constant or variable speed as the application may require.

As discussed above, the first controller 122 generally controls the opening and closing of the auger doors 119 to allow material to move from the first material handling device 102 through the auger assembly 121. In the preferred embodiment, however, the auger assembly 121 includes both automatic and manual switches to control the auger doors 119. Accordingly, the user may control the auger doors 119 if desired. However, the first controller 122 generally regulates the starting and stopping of the auger assembly 121 to move material from the first material handling device 102. When first controller 122 activates the first material handling device 102 to unload material, the auger assembly 121 will begin operating. Further, if the auger doors 119 are in automatic mode, the first controller 122 will open same. The flow of material will be influenced by the pressure necessary to move the material. Similarly, when the first controller 122 activates the first material handling device 102 to stop unloading material, the first controller 122 will close the auger doors, wait for a set time, and turn off the auger assembly 121.

Once the transport apparatus 116 is nearly full, the first controller 122 will automatically initiate shut-down of the auger 121. As discussed above, the first controller 122 may automatically self-correct based on the accuracy of the previous load. In the illustrated embodiment, the first controller 122 is automatically self-correcting to stop filling when 1120 pounds of material remains to be moved to the transport apparatus 116, which is shown as the Preact value in the System Setup data screen 180 of FIG. 11. This value will vary from load to load, unless the previous load was completely accurate. The first controller 122 will turn off the auger 121 thirty seconds after the Preact weight is reached, which is shown as the Shutdown time in the System Setup date screen 180. The controller 122 may be programmed to initiate shut-down when any amount of material remains to be moved to the transport apparatus 116. Moreover, the controller 122 may be programmed to run the auger for any amount of time after the Preact weight is reached. This shut-down signal is also transmitted to the joystick 123 to automatically trigger the joystick 123 to stop the augers. Preferably the first controller 122 and joystick 123 are hardwired to each other. However, the two components may be connected via any means known in the art, either now or in the future.

In the preferred embodiment, the transport apparatus 116 will be filled within 65 pounds of its capacity during the automatic filling process. However, this value will change based on the accuracy of the Preact value. As the user unloads more loads into a transport apparatus 116, the accuracy will increase. Moreover, the first controller 122 of the preferred embodiment will include a drop calculation function wherein the controller 122 calculates the amount of material that has left the spout but has not hit the container of the material transport apparatus 116, resulting in increased accuracy during the filling process. It should be appreciated that the transport apparatus 116 could be filled within any value of its capacity without departing from the scope of the present invention. In addition to a transport apparatus 116 with a single container for filling, the first controller 122 may be programmed to fill transport apparatuses 116 with multiple containers, such as double tank trucks, including those wherein the tanks are different capacities.

The first controller 122 may optionally be programmed to self-correct by any percentage based on the accuracy of each load into a particular transport apparatus 116. For example, if a semi-trailer may hold 10,000 pounds of material and the user programs the first controller 122 to self-correct by 50%, the first time the first material handling device 102 unloads into the trailer, it may be programmed to fill the trailer with an amount of material that is less than 10,000 pounds, for example 9000 pounds. If the capacity of the specific trailer is not changed following the first loading, the first controller 122 will then correct itself by 50%. Accordingly, in the second filling of the particular trailer, the first controller 122 will fill the transport apparatus 116 with 9500 pounds of material. If the capacity is not changed, the transport apparatus 116 will be filled with 9750 pounds of material during the third filling, and so on. As one of skill in the art will recognize, the first controller 122 may be programmed to vary the auto-correct options and values without departing from the scope of the invention. It should be noted that the auto-correct feature will correct the load in both directions to prevent both overfilling and underfilling, resulting in increased accuracy.

As discussed above, a significant advantage of the system 100 of the present invention is the ability of the first controller 122 to determine the quantity, such as the weight, of material located in the first material handling device 102, second material handling device 104, and material transport apparatus 116. The first controller 122 is adapted to use the scale measurements from the first scale 120 and second scale 124 to determine the amount of material in each piece of equipment and the amount of material between each piece of equipment. By way of example, the first controller 122 is adapted to determine the amount of material in the second material handling device auger 125 on its way to the first material handling device 102 and not included in either scale measurement to provide a real-time quantity of material in each piece of equipment. The real-time measurements lead to increased accuracy in unloading and filling each piece of equipment. Moreover, this feature allows the first material handling device 102 to simultaneously receive material from a second material handling device 104 and unload material into a material transport apparatus 116, thus contributing to efficiency during harvest. During the aforementioned simultaneous receipt and unload of material, the first controller 122 is able to determine and display the real-time quantity of material in each piece of equipment 102, 104, 116. In addition, the first material handling device 102 may simultaneously receive material from and determine the quantity of material in a plurality of material handling devices while unloading material into a material transport apparatus 116.

To carry out the features described above, the first controller 122 is in constant communication with the first scale 120 and the second scale 124, which allows the first controller 122 to continually determine the amount of material going into the first material handling device 102 and leaving same. When the second material handling device 104 begins unloading material into the first material handling device 102, the first controller 122 begins calculating the amount of material in and moving between each. If the first material handling device 102 is simultaneously unloading into a material transport apparatus 116, the first controller 122 determines the weight decrease in each device 102, 104 to calculate the weight of material in the material transport apparatus 116 and/or the material handling devices 102, 104. Even if the second material handling device 104 flows faster than the first material handling device 104, thus leading to an increase in the amount of material in the first material handling device 102, the first controller 122 determines the weight of material leaving the second material handing device 104 and entering the material transport apparatus 116. These calculations may occur any number of times without departing from the scope of the present invention, but in the preferred embodiment, the calculations occur several times per second and lead to a real-time quantity of material in each piece of equipment. As one of skill in the art will appreciate, the above calculations may occur by analyzing the weight of material in each device 102, 104 and/or the flow rate of material entering and/or leaving each device 102, 104.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between a network connection of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

1. A system for communication between material handling devices comprising:
a first material handling device comprising:
a first scale; and
a first controller adapted to receive information from said first scale;
a second material handling device comprising a second scale;
wherein said first material handling device and said second material handling device communicate; and
wherein said first controller is adapted to determine a quantity of material in at least one of said first material handling device and said second material handling device.

2. The system of claim 1 wherein:
said second material handling device further comprises a second controller adapted to receive information from said second scale; and
said second controller sends said information from said second scale to said first controller.

3. The system of claim 2 further comprising:
a wifi receiver located on said first material handling device and connected to said first controller; and
a wifi transmitter located on said second material handling device and connected to said second controller.

4. The system of claim 3 wherein at least one of said first and second material handling devices are tracked and identified via an internet protocol address.

5. The system of claim 2 wherein said quantity of material in said first material handling device is a real-time weight of material located in said first material handling device and said quantity of material in said second material handling device is a real-time weight of material located in said second material handling device.

6. The system of claim 5 wherein said second material handling device comprises a material moving means.

7. The system of claim 6 wherein said first controller is further adapted to determine the amount of material in said material moving means.

8. The system of claim 5 wherein said first material handling device simultaneously receives material from said second material handling device and unloads material into a material transport apparatus.

9. The system of claim 8 wherein said first controller is further capable of providing and displaying the amount of material moved from said first material handling device to said transport apparatus.

10. The system of claim 8 wherein said first material handling device is capable of simultaneously receiving said material from a plurality of material handling devices, unloading said material into a material transport apparatus, and displaying a real-time weight of material in each of said plurality of material handling devices.

11. The system of claim 2 wherein data from at least one of said first controller and second controller is transferable to at least one of a computer and the World Wide Web by at least one of user command and real-time transfer.

12. The system of claim 1 further comprising a material transport apparatus and wherein said first controller is adapted to receive information corresponding to the capacity of said material transport apparatus.

13. The system of claim 1 wherein said first material handling device further comprises a material moving means.

14. The system of claim 13 wherein said material moving means comprises an auger and said first controller is adapted to control said auger.

15. The system of claim 14 wherein said first material handling device further includes an auger door and said first controller is adapted to control said auger and said auger door.

16. The system of claim 15 wherein said controller is further adapted to automatically start the process of unloading material from the first material handling device.

17. The system of claim 13 wherein said first controller initiates an automatic shut-off sequence of the material moving means when a predetermined amount of material remains to be moved from said first material handling device to a material transport apparatus.

18. The system of claim 13 further comprising a manual operation device for controlling said material moving means.

19. The system of claim 18 wherein said manual operation device is a joystick.

20. The system of claim 1 wherein said first material handling device is a surge bin and said second material handling device is a grain cart.

21. A system for communication between material handling devices comprising:
a first material handling device comprising:
a first scale;
an auger; and
a first controller capable of controlling said auger;
a second material handling device comprising:
a second scale; and
a second controller adapted to receive information from said second scale;
a communication link between said first controller and said second controller;
a material transport apparatus;
said first controller adapted to receive information from said first scale and said second controller;
said first controller further adapted to store information regarding said material transport apparatus; and
wherein said first controller is adapted to provide a real-time weight of material in at least one of said first material handling device; said second material handling device; and said material transport apparatus.

22. A system for communication between a surge bin and a grain cart comprising:
a surge bin comprising:
a surge bin scale;
a system controller;
an auger capable of manipulation by said system controller and by a joystick;
a grain cart comprising:
a grain cart scale;
a grain cart controller adapted to receive real time information from said grain cart scale;
said system controller and said grain cart controller in communication;
said system controller adapted to display information from said grain cart controller;
said system controller adapted to display information from said surge bin scale;
a material transport apparatus;
said system controller further adapted to store information regarding said material transport apparatus; and
said surge bin capable of simultaneously receiving material from a plurality of grain carts and unloading a material product into said material transport apparatus;
said system controller adapted to provide a real-time quantity of material in said first material handling device, said second material handling device, and said material transport apparatus.
